(19) United States
(12) Patent Application Publication
(10) Pub. No.: US 2023/0158707 A1
(43) Pub. Date: May 25, 2023

(54) Game Piece Mold Device

(71) Applicant: Clint Bohaty, Minneapolis, MN (US)

(72) Inventor: Clint Bohaty, Minneapolis, MN (US)

(21) Appl. No.: 17/989,405

(22) Filed: Nov. 17, 2022

Related U.S. Application Data
(60) Provisional application No. 63/281,323, filed on Nov. 19, 2021.

(51) Int. Cl. B28B 7/00

(52) U.S. Cl. CPC B28B 7/0035

(57) ABSTRACT

A game piece mold device includes a pair of panels hingedly coupled together. A mold insert has front and back sections each removably couplable to the pair of panels such that pivoting of the pair of panels into a closed position is configured to form a game piece out of clay positioned between the front and back sections.

### CROSS-REFERENCE TO RELATED APPLICATIONS

I hereby claim the benefit under 35 U.S.C. Section 119(e) of U.S. Provisional application 63/281,323 filed Nov. 19, 2021.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to board games and more particularly pertains to a new board game for molding game pieces for use in playing a board game.

### (2) Description of Related Art Including Information Disclosed Under 37 CFR 1.97 and 1.98

The prior art relates to board games. Previously known board games utilize game pieces of a set structure with fixed shape. Known prior art does not provide for formation of game pieces using selectable molds.

### BRIEF SUMMARY OF THE INVENTION

An embodiment of the disclosure meets the needs presented above by generally comprising a pair of panels hingedly coupled together. A mold insert has front and back sections each removably couplable to the pair of panels such that pivoting of the pair of panels into a closed position is configured to form a game piece out of clay positioned between the front and back sections.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a game piece mold device according to an embodiment of the disclosure in an open position.

FIG. 2 is a bottom view of an embodiment of the disclosure in the open position.

FIG. 3 is a right side view of an embodiment of the disclosure.

FIG. 4 is a left side view of an embodiment of the disclosure.

FIG. 5 is a rear view of an embodiment of the disclosure.

FIG. 6 is a front view of an embodiment of the disclosure.

FIG. 7 is a top front side perspective view of an embodiment of the disclosure.

FIG. 8 is a top front side perspective view of an embodiment of the disclosure in a closed position.

FIG. 9 is a top front side perspective view of an embodiment of the disclosure in the closed position.

FIG. 10 is a top view of front and back sections of a mold insert of an embodiment of the disclosure.

FIG. 11 is a bottom view of front and back sections of the mold insert of an embodiment of the disclosure.

### DETAILED DESCRIPTION OF THE INVENTION

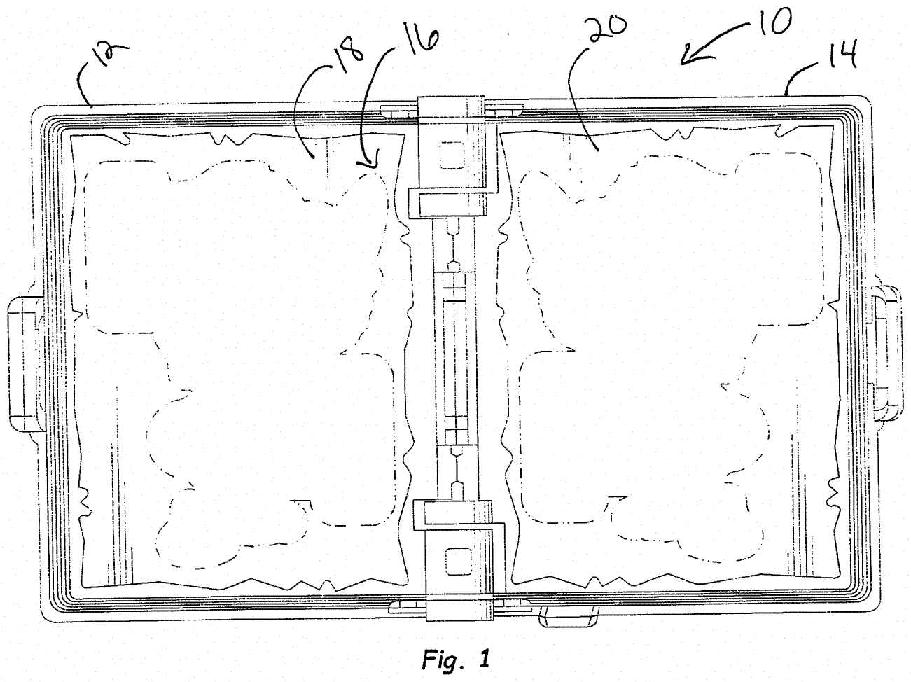

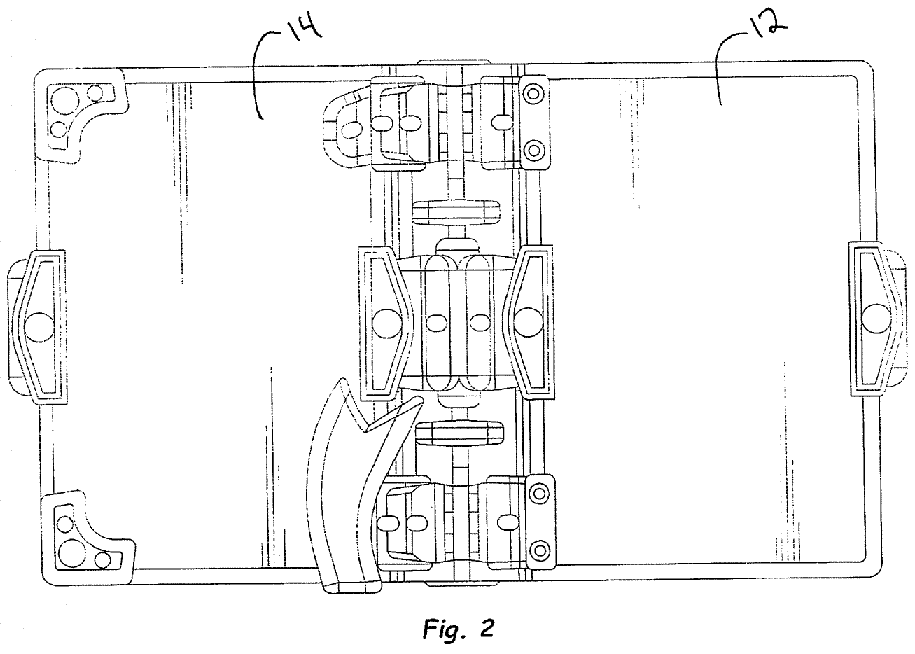

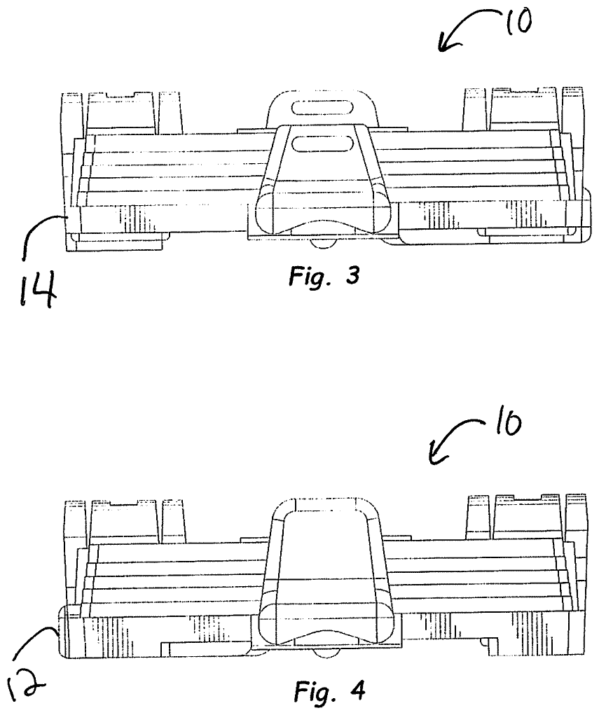

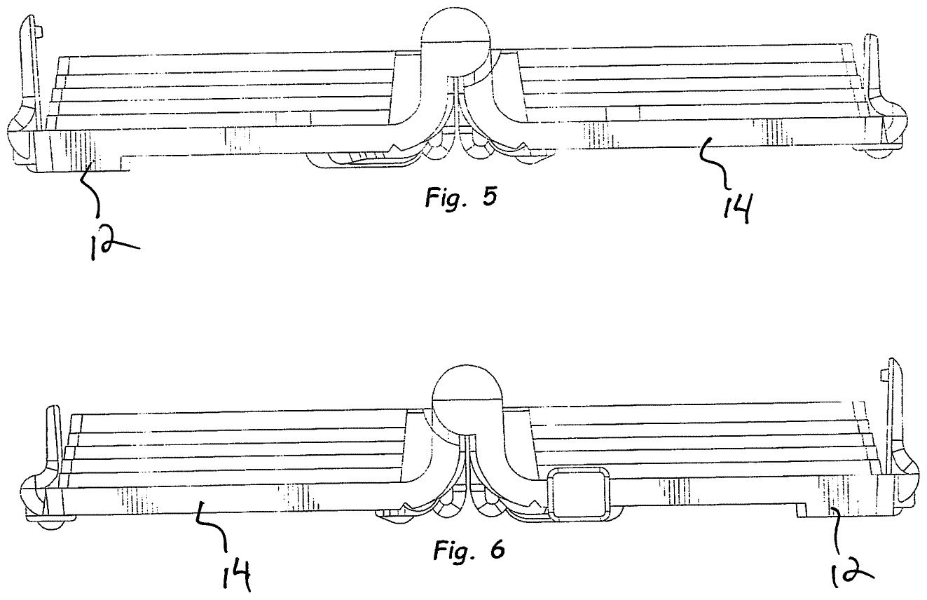

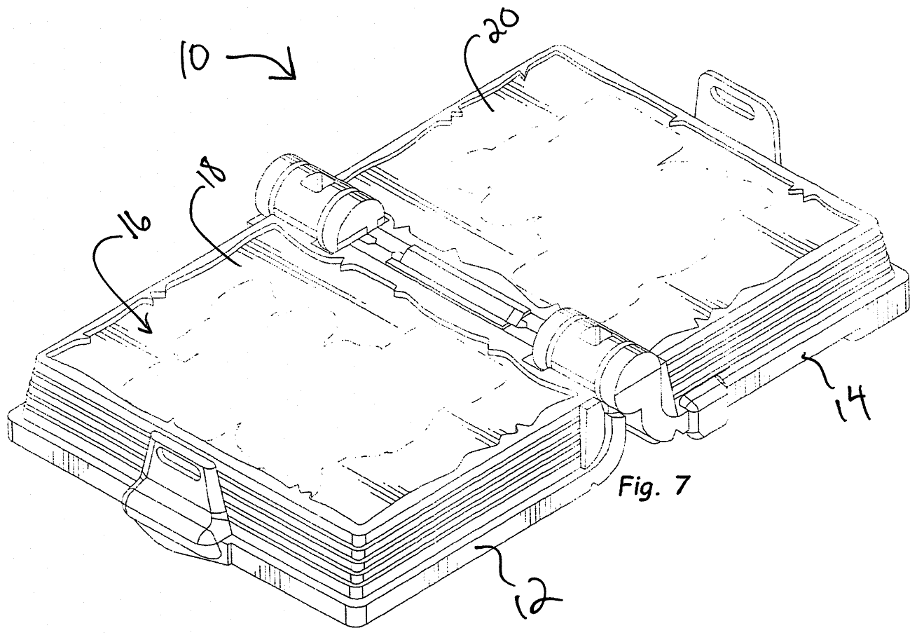

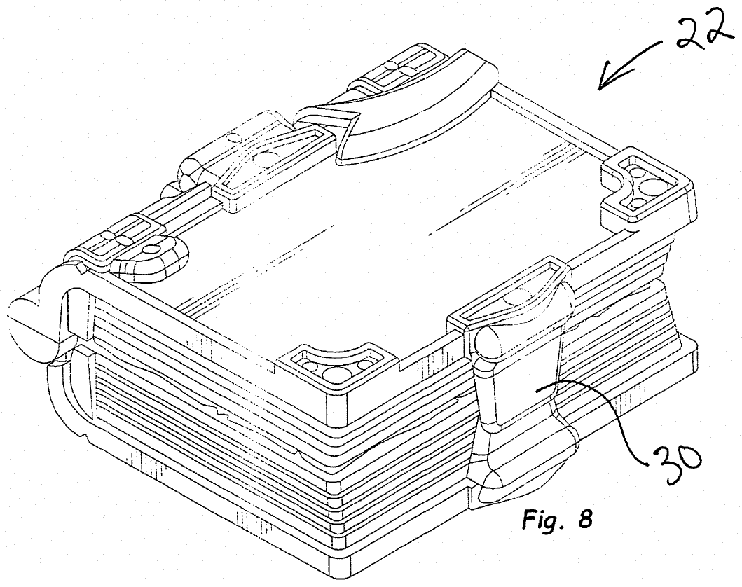

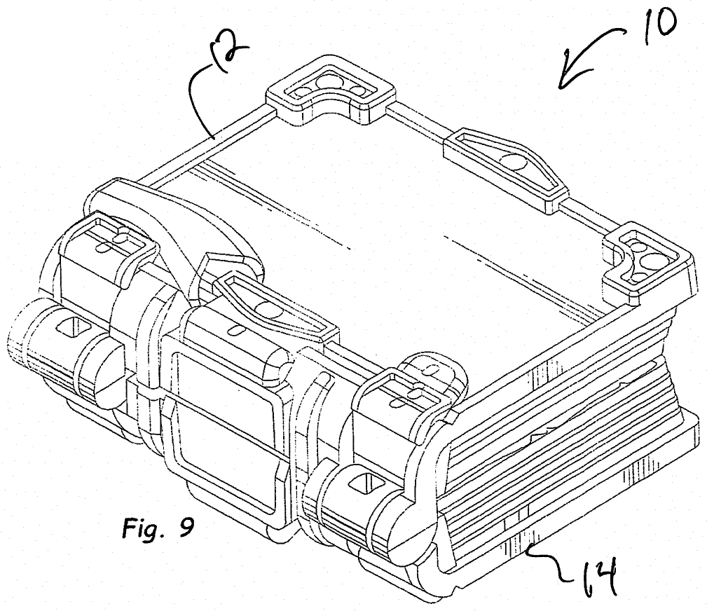

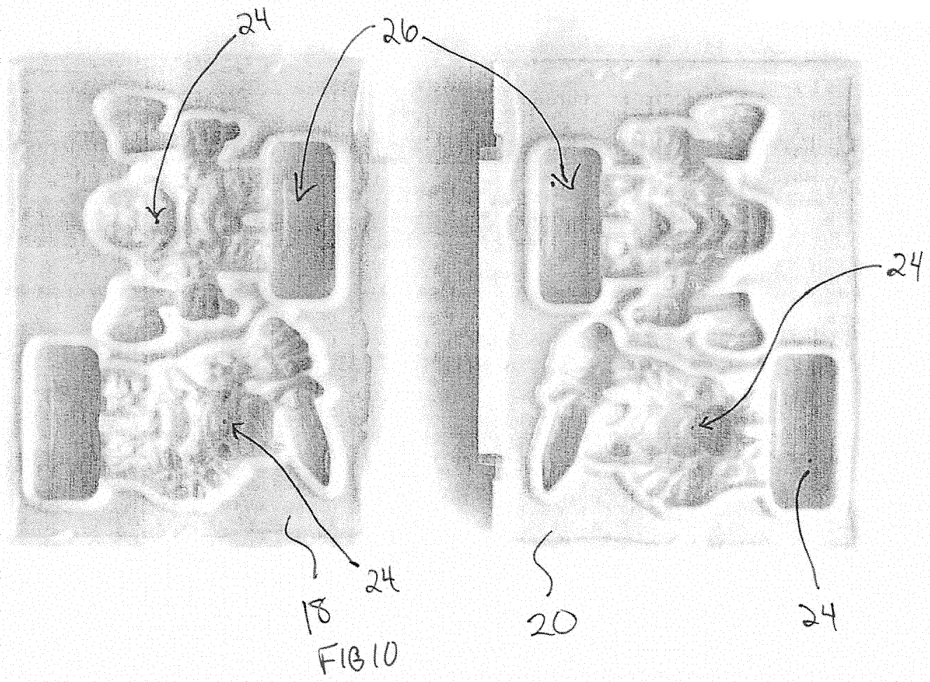

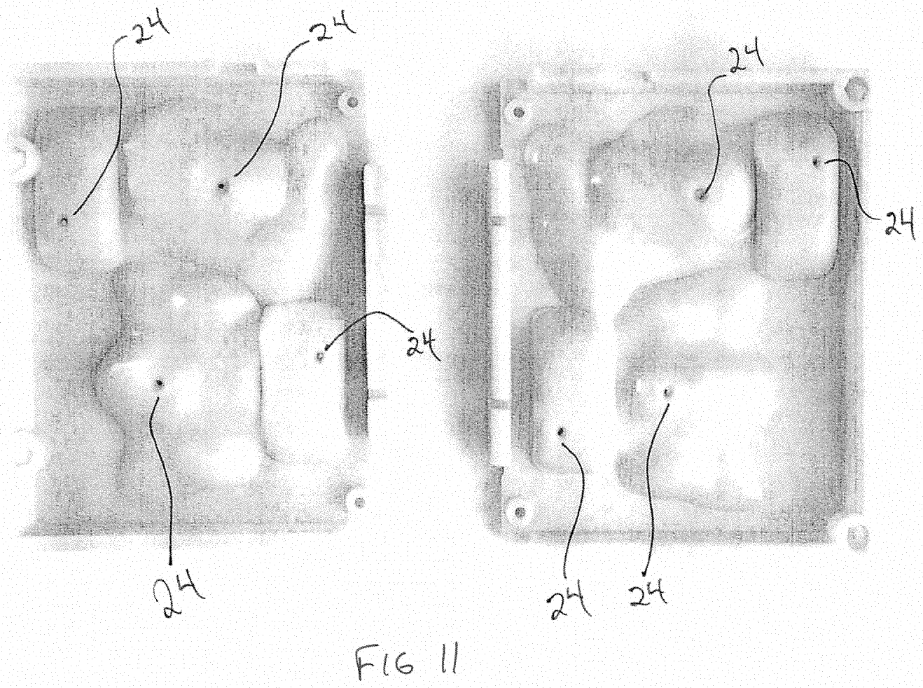

With reference now to the drawings, and in particular to FIGS. 1 through 9 thereof, a new board game piece mold embodying the principles and concepts of an embodiment of the disclosure and generally designated by the reference numeral 10 will be described.

As best illustrated in FIGS. 1 through 9, the game piece mold device 10 generally comprises a pair of panels 12,14 being hingedly coupled together. A mold insert 16 has a front section 18 and back section 20 each removably couplable to the pair of panels 12,14 such that pivoting of the pair of panels 12,14 into a closed position 22 is configured to form a game piece out of clay positioned between the front section 18 and back section 20. The pair of panels 12,14, front section 18, and back section 20 are shaped to resemble a book. The term clay is intended to encompass natural and synthetic moldable materials including clay, dough, or the like. Each of the front section 18 and the back section 20 forms an enclosed empty space 22 between the front section 18, the back section 20 and the respective panel 12,14. Each of the front section 18 and the back section 20 has holes 24 extending therethrough in environmental communication with the empty space 22. The holes 24 are positioned within a molding space 26 wherein the holes 24 are configured for allowing air and excess clay to pass through from the molding space 26 into the empty space 22. Each hole 24 has a tapered peripheral edge wherein each hole 24 has a diameter adjacent the empty space 22 being larger than a diameter adjacent to the molding space 26.

Each of the front section 18 and the back section 20 has a notch 28 therein. The notch 28 in the front section 18 and the notch 28 in the back section 20 are positioned facing the same direction when the front section 18 and back section 20 are engaged to the pair of panels 12,14. The notch 28 is in environmental communication with the empty space 22 wherein the notch 28 is configured for clay within the empty space 22 to exit the empty space 22 through the notch 28. Each of the front section 18 and the back section 20 are engageable to the pair of panels 12,14 by an interlocking pressure fit engagement such as a combination of a groove, slot, tab, protrusion, post, or similar interlocking structures. The interlocking pressure fit engagement of each of the front section 18 and back section 20 are positioned such that each of the front section 18 and back section 20 are engageable to the pair of panels 12,14 in a single orientation coordinating the positioning of the front section 18 to the back section 20. A latch 30 is coupled to the pair of panels 12,14. The latch 30 secures the panels in the closed position 22 when the latch 30 is engaged.

In use, the front section 18 and back section 20 are engaged to the pair of panels 12,14 and clay is placed between the front section 18 and back section 20. Closing of the panels 12,14 compresses the clay within the molding space 16 between the front section 18 and back section 20 to form the clay into a game piece.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A game piece mold comprising:
a pair of panels being hingedly coupled together; and
a mold insert having front and back sections each removably couplable to the pair of panels such that pivoting of the pair of panels into a closed position is configured to form a game piece out of clay positioned between the front and back sections.

2. The game piece mold of claim 1 further comprising each of the front section and the back section forming an enclosed empty space between the front section and the back section and the respective panel.

3. The game piece mold of claim 2 further comprising each of the front section and the back section having holes extending therethrough in environmental communication with the empty space, the holes being positioned within a molding space wherein the holes are configured for allowing air and excess clay to pass through from the molding space into the empty space.

4. The game piece mold of claim 3, further comprising each hole having a tapered peripheral edge wherein each hole has a diameter adjacent the empty space being larger than a diameter adjacent to the molding space.

5. The game piece mold of claim 3, further comprising each of the front section and the back section having a notch therein, the notch being in environmental communication with the empty space wherein the notch is configured for clay within the empty space to exit the empty space through the notch.

6. The game piece mold of claim 1, wherein the pair of panels, front section, and back section are shaped to resemble a book.

7. The game piece mold of claim 1, further comprising each of the front section and the back section being engageable to the pair of panels by an interlocking pressure fit engagement.

8. The game piece mold of claim 7, further comprising the interlocking pressure fit engagement of each of the front section and back sections being positioned such that each of the front section and back section are engageable to the pair of panels in a single orientation coordinating the positioning of the front section to the back section.

9. The game piece mold of claim 1, further comprising a latch coupled to the pair of panels, the latch securing the panels in the closed position when the latch is engaged.
